(19) United States
(12) Patent Application Publication
(10) Pub. No.: US 2015/0300869 A1
(43) Pub. Date: Oct. 22, 2015

(54) APPARATUSES AND METHODS FOR FUEL LEVEL SENSING

(71) Applicant: Deringer-Ney, Inc., Bloomfield, CT (US)

(72) Inventors: Arthur S. Klein, Orange, CT (US); Edward F. Smith, III, Madison, CT (US); Garth W. Boyd, Ellington, CT (US)

(21) Appl. No.: 14/255,702

(22) Filed: Apr. 17, 2014

(51) Int. Cl. G01F 23/68

(52) U.S. Cl. CPC G01F 23/68

(57) ABSTRACT

Apparatuses and methods for fuel level sensing use a rotatable housing configured to rotate about an axis based on a fuel level. Within the rotatable housing is a roller ball sensor assembly including a resistive trace having a plurality of portions, a conductive trace and a conductive element. The roller ball sensor assembly is configured to provide a resistance indicative of a rotation of the rotatable housing about the axis by using the conductive element to electrically couple a portion of the plurality of portions corresponding to the resistance to the conductive trace.

### TECHNICAL FIELD

The present disclosure relates generally to fuel level sensors, and more particularly to fuel level sensors with a rotatable housing defining an enclosed interior adapted to protect fuel level sensor elements from fuel within a fuel tank.

### BACKGROUND

Fuel level sensors are commonly used to determine fuel levels of a fuel tank. Some of these devices comprise fuel level sensors, where particular components of a fuel level sensor are enclosed in a housing to prevent the components from being directly exposed to fuel of the fuel tank. Many fuel level sensors rely on the position of an external float arm to determine fuel level of a fuel tank, where typically, each angle of the float arm is known to correspond to a particular fuel level.

In particular, determining a fuel level requires communicating a position of the float arm to a sensor located in the housing. Effectively communicating float arm positions in this manner has been proven to be a challenging task, however. Known approaches of providing float arm positions have led to a multitude of reliability issues, including leakage, poor durability, and inaccurate measurement.

### SUMMARY OF THE DISCLOSURE

A sensor assembly includes a sealed rotatable housing that rotates about an axis based on a fuel level. Within the rotatable housing is a roller ball sensor assembly, which provides a resistance indicative of a rotation of the rotatable housing about the axis. The roller ball sensor assembly includes a resistive trace having a plurality of portions, a conductive trace, and a conductive element. The roller ball sensor assembly is configured to provide the resistance indicative of the rotation of the rotatable housing about the axis by using the conductive element to electrically couple a portion of the plurality of portions corresponding to the resistance to the conductive trace.

In another implementation, an apparatus includes a roller ball sensor assembly with a first trace, a second trace and a ball configured to electrically couple a first portion of the first trace to the second trace responsive to the roller ball sensor assembly being positioned at a first angle, and to electrically couple a second portion of the first trace to the second trace responsive to the roller ball sensor assembly being positioned at a second angle. The roller ball sensor assembly provides a first resistance responsive to the ball electrically coupling the first portion of the first trace to the second trace, and provides a second resistance different from the first resistance responsive to the ball electrically coupling the second portion of the first trace to the second trace.

In yet another implementation, a method of sensing fuel levels in a fuel tank involves providing a fuel sensor that includes a rotatable housing and a roller ball sensor assembly with a resistive trace having a plurality of portions, a conductive trace and a conductive element. The roller ball sensor assembly being configured to sense a resistance indicative of a rotation of the rotatable housing about the axis by electrically coupling a portion of the plurality of portions corresponding to the resistance to the conductive trace using the conductive element.

### BRIEF DESCRIPTION OF THE DRAWINGS

FIG. 1 is a schematic diagram of a fuel level sensor in a first position according to an embodiment of the present disclosure.

FIG. 2 is a schematic diagram of the fuel level sensor of FIG. 1 in a second position according to an embodiment of the present disclosure.

FIG. 3 is a schematic diagram of the fuel level sensor of FIG. 1 in a third position according to an embodiment of the present disclosure.

FIG. 4A is a plan view of a roller ball sensor assembly according to an embodiment of the present disclosure, which may be provided in an interior of the fuel level sensor of FIG. 1.

FIG. 4B is a cross-sectional view of the roller ball sensor assembly of FIG. 4A according to an embodiment of the present disclosure.

FIG. 4C is a cross-sectional view of the roller ball sensor assembly of FIG. 4A according to an embodiment of the present disclosure.

FIG. 4D is a schematic diagram of a circuit equivalent that may be implemented in connection with the roller ball sensor assembly of FIG. 4A according to an embodiment of the present disclosure

FIG. 4E is a chart of a resistance curve according to an embodiment of the present disclosure.

FIG. 5A is a cross-sectional diagram of a roller ball sensor assembly according to an embodiment of the present disclosure, which may be provided in an interior of the fuel level sensor of FIG. 1.

FIG. 5B is a schematic diagram of the roller ball sensor assembly of FIG. 5A in a first position according to an embodiment of the present disclosure.

FIG. 5C is a schematic diagram of the roller ball sensor assembly of FIG. 5A in a second position according to an embodiment of the present disclosure.

FIG. 5D is a schematic diagram of the roller ball sensor assembly of FIG. 5A in a third position according to an embodiment of the present disclosure.

### DETAILED DESCRIPTION

Apparatuses and methods for fuel level sensing are disclosed herein. Certain details are set forth below to provide a sufficient understanding of embodiments of the present disclosure. However, it will be clear to one having skill in the art that implementations may be practiced with or without these particular details. Moreover, the particular embodiments of the present disclosure are provided by way of example and should not be construed as limiting. In other instances, well-known components, circuits, and operations have not been shown in detail as being known to those of skill in the art.

The present disclosure is directed generally to fuel level sensors. A fuel level sensor may be a sensor located in a fuel tank and configured to provide signals indicative of fuel levels of the fuel tank. Generally, a fuel sensor may include a rolling conductive element (e.g., a ball or other movable conductive structure), a resistive trace, and a conductive trace. During operation, the conductive element may electrically couple a particular portion (e.g., a digit) of the resistive trace to a portion of the conductive trace and thereby provide a conductive path having a specific resistance through the resistive trace, the conductive element, and the conductive trace. The conductive element may be displaced in accordance with fuel levels and electrically couple different portions of the resistive trace to the conductive trace. In this manner, the conductive element may adjust the resistance provided by the resistive trace, and as a result, the resistance of the conductive path. By way of example, when a fuel level is relatively low, the conductive element may cause the resistance of the conductive path to be low such that the fuel level sensor has a low resistive output, and when a fuel level is relatively high, the conductive element may cause the resistance of the conductive path to be high such that the fuel level sensor has a higher resistive output, or vice versa. Associating each resistance with a particular fuel level may be achieved using an external control logic coupled to an electrical output of the resistive trace and/or the conductive trace. In prior approaches to sealing fuel level sensors, problems typically arise when the sensor is exposed to fuel leakage proximate rotary seals where a float arm enters the interior of the fuel level sensor, and the contact and/or the resistive film on the card tends to degrade, which leads to eventual failure of the sensor. It has been discovered that fuel level sensor assemblies described herein remove the need for a rotary seal and may protect the sensor elements from contact with fuel, thereby providing a fuel level sensor that resists degradation caused by fuel ingress.

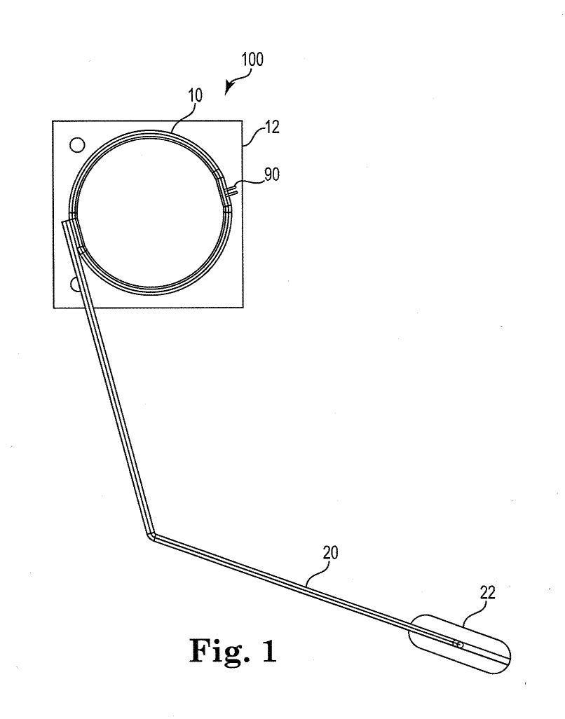

FIG. 1 is a schematic diagram of a fuel level sensor in a first position according to one implementation. The fuel level sensor assembly 100 may include a rotatable housing 10, a plate assembly 12, a float arm 20 including an external float 22, and output contacts 90.

The rotatable housing 10 may be substantially cylindrical (e.g., elliptically cylindrical) in shape. For example, the rotatable housing may be configured as a shortened cylinder and its shape may be likened to a puck or a biscuit. The housing 10 may include sidewalls arranged between opposing circular-shaped front and back walls. The sidewalls may define an outer circumferential wall, and in some instances, a portion of the outer circumferential wall of the rotatable housing 10 may include one or more relatively linear portions. The one or more portions may be used, for instance, to couple the float arm 20 to the rotatable housing 10 and/or to provide an egress for the output contacts 90. The rotatable housing 10 may be constructed of any material known in the art, now or in the future, including glass, plastic, metal, rubber, or any combination thereof, and accordingly may be configured to resist and/or mitigate corrosion from one or more liquid fuels.

The rotatable housing 10 may be sealed using laser welding, injection of a sealing polymer, compression of an O-ring seal, adhesive or a combination thereof. Accordingly, the rotatable housing 10 may be liquid tight and/or filled with a viscous fluid. Where the rotatable housing 10 is filled with a viscous fluid, debris or other contaminants that would otherwise accumulate between components of the rotatable housing 10 may be prevented from doing so. In some instances, the viscous fluid may further act as a lubricant for and/or may prevent sudden jostling of one or more of the components of the rotatable housing 10. In at least one example, the viscous fluid may be an inert fluid, a dielectric fluid, or any combination thereof. In some examples, the rotatable housing 10 may only be partially filled with the viscous fluid, and any portion of the rotatable housing 10 not filled with the viscous fluid may be filled with an inert gas, such as argon or nitrogen. In some examples, the non-conductive fluid may not chemically react with components of the fuel level sensor 100, including the housing 10.

The plate assembly 12 may be coupled to the rotatable housing 10 such that the plate assembly 12 circumferentially encloses at least a portion of the rotatable housing 10 to allow the rotatable housing 10 to rotate within the plate assembly 12. A portion of the plate assembly 12 may be fixedly joined to an interior surface (e.g., vertical interior surface) of a fuel tank, thereby holding the rotatable housing 10 within the fuel tank. In some examples, the plate assembly 12 may be fixed within a fuel pump module, or may be fixed to a bracket located within the fuel tank. The plate assembly, thus, may prevent the rotatable housing 10 from being displaced relative to the fuel tank, yet still allow the rotatable housing 10 to rotate as described herein.

The float arm 20 may be joined to the rotatable housing 10 and configured to change position in response to changes in fuel level within fuel tank, resulting in rotation of the rotatable housing 10, and thus operation of the fuel level sensor 100, described below. The float arm 20 may include a buoyant float 22 that rises and falls with the fuel level of the fuel tank thereby causing the float arm 20 to rise and fall in response. With reference to FIG. 1, in some examples, the float arm 20 may be coupled to the exterior edge of the rotatable housing 10. In other examples, the float arm 20 may be coupled to an axle extending from the rotatable housing 10 or a flat portion of the rotatable housing 10.

In operation, the fuel level sensor assembly 100 may generally be used to determine a fuel level in a fuel tank. As the float arm 20 rises and falls with respective fuel levels, the rotatable housing 10 may be slaved in rotation relative to the plate assembly 12. For example, the rotatable housing 10 may rotate in a first direction (e.g., clockwise) responsive to the float arm 20 falling, and may rotate in a second direction (e.g., counter-clockwise) responsive to the float arm 20 rising, and the fuel level sensor components within the sealed housing 10 may operate in response to such movement of the float arm 20, for instance, by altering the resistance of the circuit path between the output contacts 90.

In an example operation of the fuel level sensor assembly 100, a fuel level of a fuel tank may be at a particular level, and as described, the float arm 20 may be displaced at a particular height based on the fuel level. Thus, the rotatable housing 10 coupled to the float arm 20 may be at a particular angle and based on the angle of the sealed housing, the fuel level sensor components within the sealed housing 10 may operate to complete a conductive path between the output contacts 90 having a resistance corresponding to the fuel level. An external circuit coupled to the output contacts 90 of the fuel level sensor assembly 100 may determine the resistance of the conductive path between the contacts 90, and based on the resistance of the conductive path, may indicate the fuel level.

As the fuel level of the fuel tank changes, the height of the float arm 20 may change as well, and the float arm 20 may rotate the rotatable housing 10 relative to the plate assembly 12 in accordance with the change in fuel level. This rotation may change the orientation of the rotatable housing 10 resulting in the fuel level sensor components within the sealed housing 10 completing a different conductive path between the contacts 90 having a different resistance. As the contacts 90 may be coupled to an external circuit, described above, the resistance of the conductive path may be used to determine the new fuel level of the fuel tank.

In some examples, output contacts 90 need not be provided outside of the housing 10 and/or the contacts 90 may be omitted. For instance, signals indicative of fuel levels may be provided from the rotatable housing 10 using wireless communication. Power for such communications may be generated using a battery and/or from motion of one or more components included in the housing 10, described below.

With reference to FIG. 1, the fuel level sensor assembly 100 is shown in a position in an instance in which a fuel tank has a low fuel level (e.g., the fuel tank is empty or near empty). Due to the low fuel level, the rotatable housing 10 may have an angle corresponding to the low fuel level and the conductive path between the contacts 90 may have a resistance corresponding to the low fuel level.

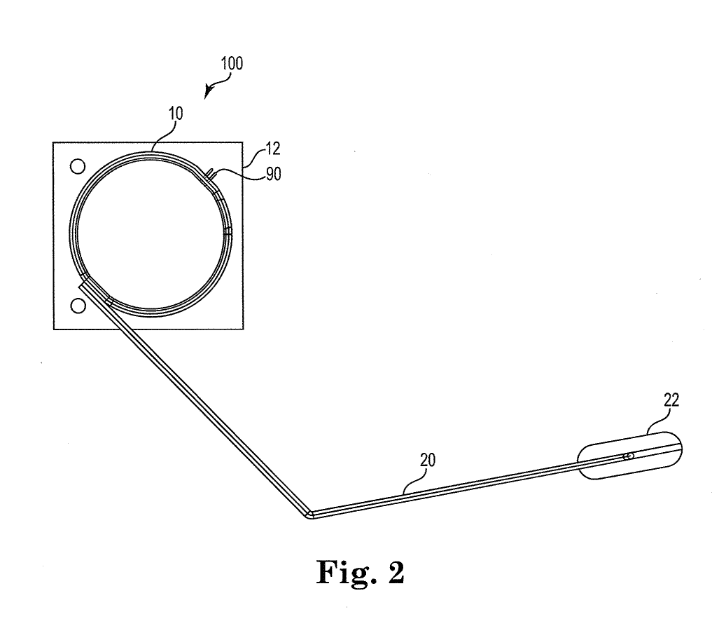

With reference to FIG. 2, the fuel level sensor assembly 100 is shown in a position in an instance in which a fuel tank has a moderate fuel level (e.g., the fuel tank is approximately half full). Due to the moderate fuel level, the rotatable housing 10 may have an angle corresponding to the moderate fuel level and the conductive path between the contacts 90 may have a resistance corresponding to the moderate fuel level.

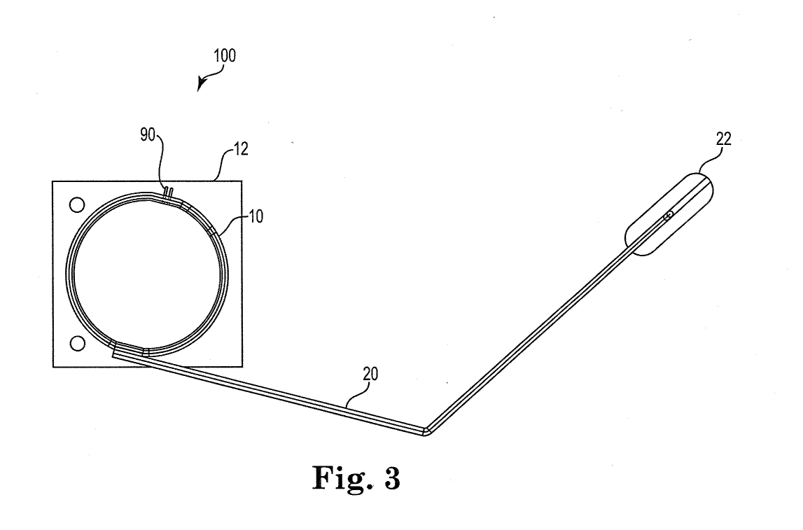

With reference to FIG. 3, the fuel level sensor assembly 100 is shown in a position in an instance in which a fuel tank has a high fuel level (e.g., the fuel tank is near full or full). Due to the high fuel level, the rotatable housing 10 may have an angle corresponding to the high fuel level and the conductive path between the contacts 90 may have a resistance corresponding to the high fuel level.

As described, components within the housing 10 may alter the resistance of a conductive path between the output contacts 90 in response to changes in fuel level of a fuel tank. In some examples, roller ball sensor assemblies, such as those described herein, may be used to alter the resistance of the conductive path between the output contacts 90. It will be appreciated, however, resistances of a conductive path may be adjusted in response to changes in fuel level of a fuel tank using other approaches as well.

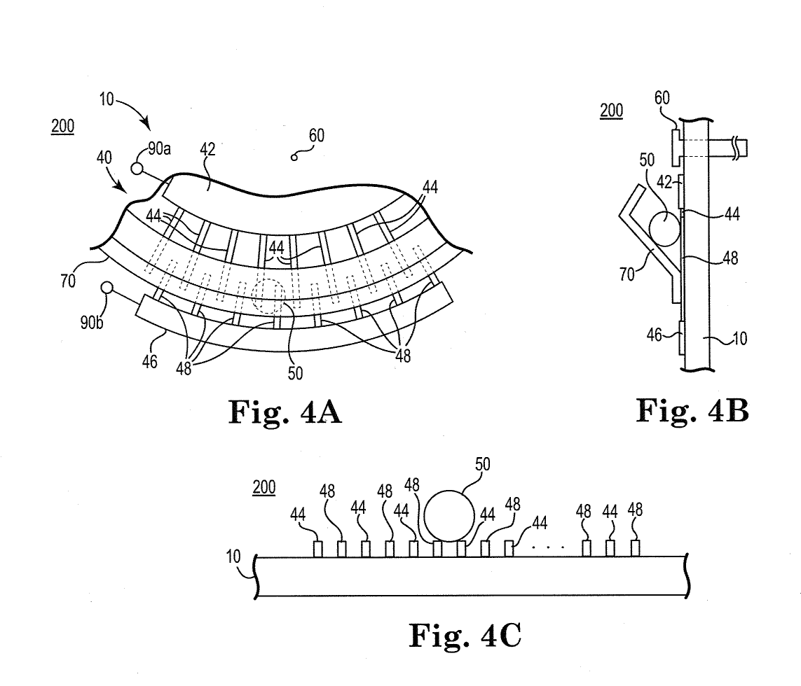

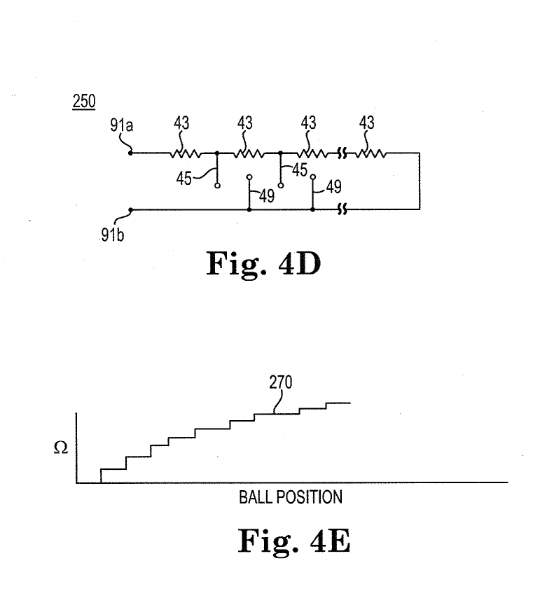

FIGS. 4A-4C illustrate various views of a roller ball sensor assembly 200 according to an embodiment of the present disclosure. The roller ball sensor assembly 200 may include a resistive trace 42 including digits 44, a conductive trace 46 including digits 48, a conductive element 50, an axle 60, a retainer 70, and contacts 90a and 90b. It will be appreciated by those having ordinary skill in the art that the contacts 90a,b may be used to implement the contacts 90 of the fuel level sensor 100 of FIGS. 1-3. In some examples, the roller ball sensor assembly 200 may be implemented in the rotatable housing 10 of the fuel level sensor 100 of FIG. 1 and used to alter the resistance of a conductive path to indicate fuel levels of a fuel tank. Accordingly, the roller ball sensor assembly 200 is illustrated in FIGS. 4A-4C as being implemented on an interior side of the rotatable housing 10. It will be appreciated, however, that the roller ball sensor assembly 200 may be implemented in other housings and/or enclosures and further may be used in other level sensing applications as well.

The resistive trace 42 may be located on the housing 10 and may be substantially arcuate. In some examples, the resistive trace 42 may be coupled (e.g., electrically coupled) to the contact 90a, and in particular may be coupled to the contact 90a at one end of the resistive trace 42. The resistive trace 42 may comprise any resistive ink and accordingly may be implemented (e.g., fired) on any number of substrates. For example, the resistive trace 42 may be printed (e.g., directly printed) on the housing 10, as illustrated, or alternatively may be printed on an FR-4 board, a kapton tape, a ceramic substrate, or combinations thereof, which may in turn be fixedly attached to the housing 10. In some embodiments, the resistive trace 42 may be implemented using polymeric ink, or may be implemented using cermet-type ink. In embodiments relying on cermet-type ink, a substrate of the resistive trace 42 may include ceramic, glass and/or porcelain-coated metal configured to withstand firing temperatures associated with cermet-type ink. In some examples, the resistive properties of the cermet-type ink may be controlled by varying the amount of ruthenium oxide or other high temperature oxides included in the cermet-type ink. Amounts of oxides may be varied, for instance, prior to firing the cermet-type ink.

The conductive trace 46 may be implemented on any number of substrates, including the housing 10, and may be substantially arcuate. In some examples, the conductive trace 46 may have substantially the same shape as the resistive trace 42. In other examples, the conductive trace 46 and the resistive trace 42 may be concentric arcs and/or have a common center point. With reference to FIG. 4A, the conductive trace 46 is shown as having a larger arc radius than the resistive trace 42, though it will be appreciated that the resistive trace 42 and the conductive trace 46 may be switched such that the resistive trace 42 has a larger arc radius. The conductive trace 46 may be coupled (e.g., electrically coupled) to the contact 90b, and in particular, may be coupled to the contact 90b at an end of the conductive trace 46. The conductive trace 46 may comprise any conductive material. By way of example, the conductive trace 46 may comprise electro-deposited pure metals such as copper, silver or nickel, electrodeposited metal alloys, conductive etched laminates, or metal, C or graphene containing inks, or a combination thereof. If base metals are used, a gold or other suitable overplate with an appropriate diffusion barrier should be used on the portion of the trace contacting the rolling element to reduce potential wear/tarnish induced signal noise.

With reference to FIG. 4A, each of the resistive trace 42 and the conductive trace 46 may include a plurality of digits. For instance, the resistive trace 42 may include the digits 44 and the conductive trace 46 may include the digits 48. Each of the digits 44, 48 may be substantially linear in shape and/or may be implemented using a conductive ink, such as a Ag, Pd—Ag or Au based powder or alloy embedded either a glass/ceramic or polymeric carrier, depending on ink formulation, or gold plated copper in an etched pattern on a PC board or other similar techniques. The digits 44 and the digits 48 may extend out from the resistive trace 42 and the conductive trace 46, respectively, such that the digits 44, 48 are interdigitated, yet electrically isolated from one another. By way of example, the digits 44, 48 may be arranged such that adjacent digits are physically spaced apart and further such that none of the digits 44 are directly adjacent to another digit 44 and none of the digits 48 are directly adjacent to another digit 48.

The conductive rolling element 50 may be substantially spherical in shape and further may comprise one or more durable electrically conductive materials (e.g., copper, gold, nickel, silver, palladium, platinum, or alloys containing these metals) provided as a surface coating. The conductive element 50 may be sized such that the conductive element 50 may at most contact a digit 44 and a digit 48 adjacent the digit 44 at any given time during operation. With reference to FIG. 4C, in some examples, the conductive element 50 may be sized such that the conductive element 50 is configured to rest on adjacent digits 44, 48 (recall that in some examples a digit 44 may not be adjacent to another digit 44 and a digit 48 may not be adjacent to another digit 48) but not contact the housing 10. Because the conductive element 50 may be electrically conductive, in some instances the conductive element 50 may be configured to electrically couple adjacent digits, described further below.

The axle 60 may be integrally formed by the rotatable housing 10 such that rotation of the housing 10 results in rotation of the axle 60. Alternatively, the axle may non-rotatably extend from the plate assembly 12 through an opening defined by walls of the rotatable housing 10 so that the rotatable housing 10 rotates about the axle 60, with the housing 10 sealed by the walls defining the opening. In either case, the axle 60 may be disposed through a central axis of the rotatable housing 10 to enable the rotatable housing 10 to rotate about its central axis. In other examples, the axle 60 may be offset relative to the central axis of the rotatable housing, and/or may be coupled to an exterior surface of the rotatable housing 10.

With reference to FIGS. 4A-B, the retainer 70 may be coupled to the housing 10 and may have an arc shape such that the retainer 70 is disposed between the resistive trace 42 and the conductive trace 46. In at least one embodiment, an interior wall of the retainer 70 may define a cavity spanning over each of the digits 44, 48 as illustrated in FIG. 4B, and the cavity may be configured to receive the conductive element 50 to enable the conductive element 50 to freely move, e.g., roll, therein, due to gravity. By way of example, the conductive element 50 may roll to a lowest point of the cavity of the retainer 70, for instance, as the retainer 70 rotates as a function of the housing 10 about the axle 60. In some examples, the retainer 70 may fully or partially enclose the conductive element 50 such that the conductive element 50 may not escape the cavity regardless of orientation. The retainer 70 may comprise any non-conductive material, such as plastic or rubber, and may be coupled to the housing 10 using an appropriate technique such as adhesive (e.g., glue), one or more fasteners (e.g., screws, bolts), welding, etc. or combinations thereof.

Contacts 90a and 90b may provide a conductive path to an exterior of the housing 10. In some examples, the resistive trace 42 may be configured to provide resistance to a conductive path extending between the contact 90a to the contact 90b and including the resistive trace 42, the conductive element 50, and the conductive trace 46. The resistive trace 42 may provide any range and/or resolution of resistances, and may use any manner of filler, layout, and firing schedule to achieve a particular sheet resistance (e.g., as measured in ohms/sq).

Because each of the digits 44 may be located at a respective portion of the resistive trace 42, a respective resistance between the contact 90a and each digit 44 may vary. By way of example, the shorter the path through the resistive trace 42, the lower the resistance provided to the conductive path by the resistive trace 42. Put another way, the nearer a digit 44 to the contact 90a, the lower the resistance between the contact 90a and the digit 44, and conversely, the farther a digit 44 from the contact 90a, the greater the resistance between the contact 90a and the digit 44. In this manner, the resistive trace 42 may provide a stepwise range of resistances using the digits 44. In some examples, the stepwise variation between resistances may be linear, or based on any other continuously increasing or decreasing function.

Accordingly, the resistive trace 42 may provide varying resistances to the conductive path as determined by the conductive element 50. The conductive element 50 may couple particular digits 44 to adjacent digits 48 based on rotation of the housing 10 (recall that rotation of the housing 10 may be based on a fuel level) and cause the conductive path to have a resistance indicative of a fuel level of a fuel tank. In an example operation of the roller ball assembly 200, the housing 10 may be at a particular angle based on the fuel level, as described, and components of the roller ball sensor assembly 200 may be at an angle based on the fuel level as well. The conductive element 50 may be located at a lowest point of the retainer 70, for instance, due to gravity and based on the location of the conductive element 50, the conductive element 50 may be electrically couple a particular digit 44 and a particular digit 48 such that the conductive path between the contact 90a and contact 90b has a resistance corresponding to the fuel level. An external circuit coupled to the contacts 90a,b may determine the resistance of the conductive path between the contacts 90a,b, and based on the resistance of the conductive path, may be used to measure the fuel level.

As the fuel level of the fuel tank changes, the angle of the housing 10 may change, causing the angle of the roller ball sensor assembly 200 to change as well. By way of gravity, the conductive element 50 may remain in and/or return to substantially the same location. In this manner, the resistive trace 42 and the conductive trace 46 may be rotated relative to the conductive element 50 such that the conductive element 50 electrically couples a different digit 44 and/or a different digit 48. Accordingly, the resistance of the conductive path between the contacts 90a,b may change in accordance with the new fuel level. As the contacts 90a,b may be coupled to an external circuit, described above, the resistance of the conductive path of the may be used to determine the new fuel level of the fuel tank.

As described herein, the conductive element 50 may operate within a cavity by way of gravity to couple respective portions of the resistive trace 42 to the conductive trace 46. Briefly, during operation, the conductive element 50 may remain at or tend to return to a lowest point of the cavity. In other examples, the conductive element 50 may be buoyant, and the orientation of the resistive trace 42, the conductive trace 46, and the retainer 70, may be rotated 180-degrees such that the cavity extends in a downward direction. Accordingly, because the housing 10 may be partially or fully filled with fluid, the conductive element 50 may be configured to float within the cavity such that the conductive element 50 remains at or tends toward a highest point of the cavity during rotation of the housing 10. In this manner, the conductive element may couple one or more portions of the resistive trace 42 to the conductive trace 46 to provide resistances indicative of fuel level.

FIG. 4D is a schematic diagram of a circuit equivalent 250 according to an embodiment of the present disclosure. The circuit equivalent 250 may include resistors 43, nodes 45, nodes 49, and contacts 91a,b.

Briefly, the circuit equivalent 250 may comprise a circuit equivalent of a roller ball sensor assembly, such as the roller ball sensor assembly 200 of FIGS. 4A-4C. Accordingly, the resistors 43 may correspond to respective resistances provided by the resistive trace 42, the nodes 45 and the nodes 49 may correspond to digits 44 and digits 48, respectively, and contacts 91a,b may correspond to contacts 90a,b, respectively.

As described with respect to FIGS. 4A-4C, the conductive element 50 may be configured to couple a digit 44 to an adjacent digit 48 during operation to indicate the resistance of a conductive path. Analogously, and with reference to FIG. 4D, a node 45 may be coupled to an adjacent node 49 to form a conductive path extending from the contact 91a, through one or more resistors 43, a node 45, and a node 49, to the contact 91b. The resistance of the conductive path may be determined based on the total resistance of the resistors 43. Because, as described, the resistive trace 42 may provide any resistance, each of the resistors 43 may have any resistance, and may have a same resistance or may vary in resistance.

As previously discussed, the resistive trace 42 may provide a stepwise range of resistances. Thus, with reference to FIG. 4E, a resistance curve 270 illustrates respective resistances of a conductive path as a function of a position of a conductive element, such as the conductive element 50. As the conductive element 50 may be displaced within the retainer 70 in response to rotation of the roller ball sensor assembly 200, the conductive element 50 may electrically couple various adjacent digits 44, 48 as described, and the resistance of the conductive path may vary in a stepwise manner based on the displacement of the conductive element 50. As illustrated, in some examples, resistances may change in a non-linear manner, though it will be appreciated that resistances may change in a stepwise linear manner if desired.

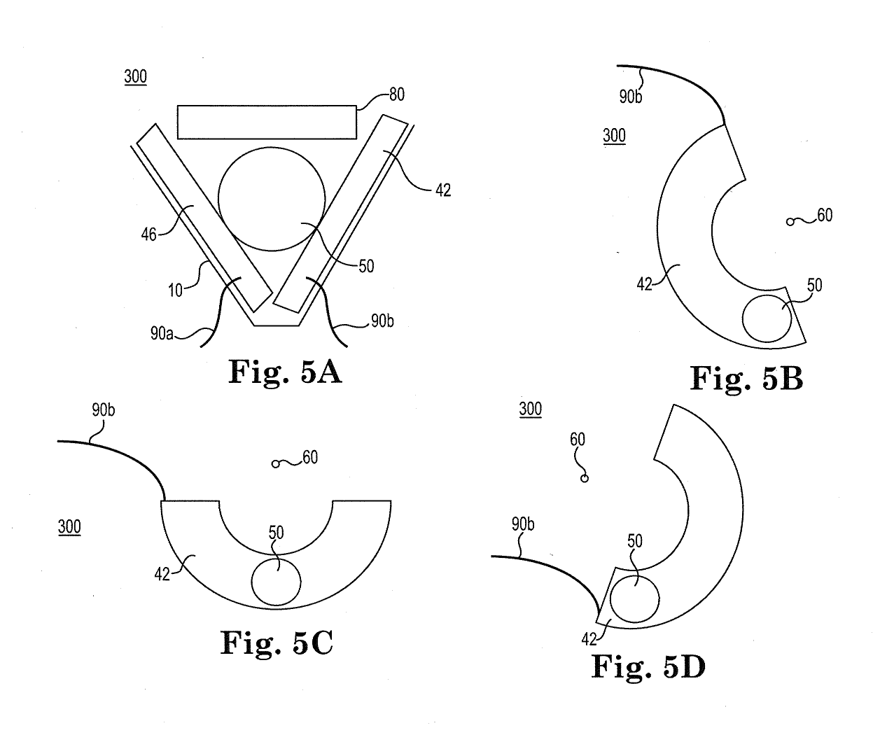

FIGS. 5A-5D illustrate various views of a roller ball sensor assembly 300 according to an embodiment of the present disclosure. The roller ball sensor assembly 300 may include a resistive trace 42, a conductive trace 46, a conductive element 50, an axle 60, a cover 80, and contacts 90a,b. It will be appreciated by those having ordinary skill in the art that the contacts 90a,b may be used to implement the contacts 90 of the fuel level sensor 100 of FIGS. 1-3. In some examples, the roller ball sensor assembly 300 may be implemented in the rotatable housing 10 of the fuel level sensor 100 of FIG. 1 and used to adjust a resistance of a conductive path to indicate fuel levels of a fuel tank. Accordingly, the roller ball sensor assembly 300 is illustrated in FIGS. 5A-4D as being implemented on an interior side of the rotatable housing 10. It will be appreciated, however, that the roller ball sensor assembly 300 may be implemented in other housings and/or enclosures and further may be used in other level sensing applications as well.

Each of the resistive trace 42 and the conductive trace 46 may be implemented on one or more respective substrates. For example, each of the resistive trace 42 and the conductive trace 46 may be printed on the housing 10, or may be printed on one or more other substrates that may in turn be fixedly attached to the housing 10. As previously discussed, the resistive trace 42 may comprise any resistive ink, such as polymeric and/or cermet-type ink. The conductive trace 46 may comprise any conductive material.

With reference to FIG. 5A, each of the resistive trace 42 and the conductive trace 46 may be arranged to form a cavity over which the cover 80 may be located. The conductive element 50 may be located within the cavity and configured to electrically couple a portion of the resistive trace 42 to the conductive trace 46. The cover 80 may serve to ensure that the conductive element 50 remains within the cavity during operation. With reference to FIGS. 5B-5D, each of the resistive trace 42, the conductive trace 46, and the cover 80 may be arcuately shaped such that the conductive element 50 may be displaced during rotation of the housing 10, for instance, about the axle 60.

The axle 60 may extend through the rotatable housing 10 and may be affixed to the rotatable housing 10 such that rotation of the housing 10 results in rotation of the axle 60. Alternatively, the axle may non-rotatably extend from the plate assembly 12 through an opening defined by walls of the rotatable housing 10 so that the rotatable housing 10 rotates about the axle 60. In either case, the axle 60 may be disposed through a central axis of the rotatable housing 10 to enable the rotatable housing 10 to rotate about its central axis. In other examples, the axle 60 may be offset relative to the central axis of the rotatable housing, and/or may be coupled to an exterior surface of the rotatable housing 10.

Each of the traces may be coupled to a respective contact 90. For instance, the resistive trace 42 may be coupled to the contact 90b and the conductive trace 46 may be coupled to the contact 90a. In some examples, the resistive trace 42 may be configured to provide resistance to a conductive path extending between the contact 90a to the contact 90b, and including the resistive trace 42, the conductive element 50, and the conductive trace 46. The resistive trace 42 may provide any range and/or resolution of resistances, and may use any manner of filler, layout, and firing schedule to achieve a particular sheet resistance (e.g., as measured in ohms/sq).

Because the conductive element 50 may be electrically conductive, the location of the conductive element 50 may determine the resistance of the conductive path. For example, the conductive element 50 may couple portions of the resistive trace 42 to the conductive trace 46 during operation such that a resistance provided by resistive trace 42 varies based on a fuel level. In one embodiment, for example, the closer the conductive element 50 to the contact 90a, the lower the resistance provided by the resistive trace 42, and conversely, the farther the conductive element 50 from the contact 90a, the greater the resistance provided by the resistive trace 42.

Accordingly, the resistive trace 42 may provide varying resistances to the conductive path as determined by the conductive element 50. The conductive element 50 may couple the resistive trace 42 to the conductive trace 46 at particular portions of the resistive trace 42 based on rotation of the housing 10 and thereby indicate a fuel level of a fuel tank. In an example operation of the roller ball assembly 300, the housing 10 may be at a particular angle based on the fuel level, as described, and components of the roller ball sensor assembly 300 may be at an angle based on the fuel level as well. The conductive element 50 may be located at a lowest point of the cavity formed by the traces 42, 46, and the cover 80, for instance, due to gravity. The conductive element 50 may electrically couple the resistive trace 42 and the conductive trace 46 such that the conductive path between the contact 90a and contact 90b has a resistance corresponding to the fuel level. An external circuit coupled to the contacts 90a,b may determine the resistance of the conductive path between the contacts 90a,b, and based on the resistance of the conductive path, may determine the fuel level.

As the fuel level of the fuel tank changes, the angle of the housing 10 may change, causing the angle of the roller ball sensor assembly 300 to change as well. By way of gravity, the conductive element 50 may remain in and/or return to substantially the same location. In this manner, the resistive trace 42 and the conductive trace 46 may be rotated relative to the conductive element 50 such that the conductive element 50 electrically couples a different portion of the resistive trace 42 to the conductive trace 46. Accordingly, the resistance of the conductive path between the contacts 90a,b may change. As the contacts 90a,b may be coupled to an external circuit, described above, the resistance of the conductive path of the may be used to indicate the new fuel level of the fuel tank.

While the roller ball sensor assembly 300 has been described as including particular elements, in some examples, the roller ball sensor assembly 300 may include additional elements and/or may omit one or more described elements. By way of example, in some examples the cover 80 may be omitted and the conductive element 50 may remain in a cavity formed by the resistive trace 42 and the conductive trace 46 as a result of gravity. In another example, the conductive trace 46 may be replaced by a resistive trace. In this manner, additional resistance may be provided by the conductive path, providing, for instance, a greater range of total resistance by which fuel levels may be indicated. In another example, the cavity enclosure may be fabricated as an integral part of the housing 10. In this case, if the housing is made from a conductive material it may serve as the conductive trace in the circuit. In the example using a conductive housing to form the cavity enclosure, an additional conductive layer may be added along the conduction path to help reduce signal noise or wear.

With reference to FIG. 5B, the roller ball sensor assembly 300 is shown in a position in an instance in which a fuel tank has a low fuel level (e.g., the fuel tank is empty or near empty). The position of the roller ball sensor assembly 300 in FIG. 5B may correspond to the position of the rotatable housing 10 in FIG. 1. Due to the low fuel level, the resistive trace 42 and conductive trace 46 may be positioned at an angle corresponding to the low fuel level. As illustrated, the conductive element 50 may be displaced to a lowest point of the cavity formed by the resistive trace 42 and the conductive trace 46 and electrically couple a portion of the resistive trace 42 to the conductive trace 46 such that the conductive path between the contacts 90a,b may have a resistance corresponding to the low fuel level.

With reference to FIG. 5C, the roller ball sensor assembly 300 is shown in a position in an instance in which a fuel tank has a moderate fuel level (e.g., the fuel tank is approximately half full). The position of the roller ball sensor assembly 300 in FIG. 5C may correspond to the position of the rotatable housing 10 in FIG. 2. Due to the moderate fuel level, the resistive trace 42 and conductive trace 46 may be positioned at an angle corresponding to the moderate fuel level. As illustrated, the conductive element 50 may be displaced to a lowest point of the cavity formed by the resistive trace 42 and the conductive trace 46 and electrically couple a portion of the resistive trace 42 to the conductive trace 46 such that the conductive path between the contacts 90a,b may have a resistance corresponding to the moderate fuel level.

With reference to FIG. 5D, the roller ball sensor assembly 300 is shown in a position in an instance in which a fuel tank has a high fuel level (e.g., the fuel tank is near full or full). The position of the roller ball sensor assembly 300 in FIG. 5D may correspond to the position of the rotatable housing 10 in FIG. 3. Due to the high fuel level, the resistive trace 42 and conductive trace 46 may be positioned at an angle corresponding to the high fuel level. As illustrated, the conductive element 50 may be displaced to a lowest point of the cavity formed by the resistive trace 42 and the conductive trace 46 and electrically couple a portion of the resistive trace 42 to the conductive trace 46 such that the conductive path between the contacts 90a,b may have a resistance corresponding to the high fuel level.

As described herein, the conductive element 50 may operate within a cavity by way of gravity to couple respective portions of the resistive trace 42 to the conductive trace 46. Briefly, during operation the conductive element 50 may remain at or tend to return to a lowest point of the cavity. In other examples, the conductive element 50 may be buoyant, and the orientation of the resistive trace 42 and conductive trace 46 may be rotated 180-degrees such that the cavity extends in a downward direction. Accordingly, because the housing 10 may be partially or fully filled with fluid, the conductive element 50 may be configured to float within the cavity such that the conductive element 50 remains at or tends toward a highest point of the cavity during rotation of the housing 10. In this manner, the conductive element may couple one or more portions of the resistive trace 42 to the conductive trace 46 to provide resistances indicative of the fuel level.

The roller ball sensor assemblies 200, 300 have been shown and described as including a single conductive path completed by movement of the conductive element 50 and housing 10 in response to changing fuel levels. In some cases using the construction shown in FIGS. 5A-5D, the resistive traces may be continuous and produce a continuous rather than stepwise resistive response. In further implementations, multiple roller ball sensor assemblies may be provided within a fuel level sensor assembly. Providing multiple roller ball sensor assemblies may enable a fuel level sensor assembly to be constructed with redundancies that ensure operation of the fuel level sensor assembly even where, for instance, one conductive element 50 is inhibited from rolling in response to changing fuel levels. In these examples, the use of multiple roller balls 50 with the appropriately sized cavities for each ball allows for the incorporation of different diameters to compensate for other factors such as vibrational frequencies.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. A sensor assembly, comprising:
a sealed rotatable housing configured to rotate about an axis based on a fuel level and comprising a roller ball sensor assembly, the roller ball sensor assembly configured to provide a resistance indicative of a rotation of the rotatable housing about the axis,
wherein the roller ball sensor assembly comprises:
a resistive trace having a plurality of portions;
a conductive trace; and
a conductive element,
wherein the roller ball sensor assembly is configured to provide the resistance indicative of the rotation of the rotatable housing about the axis by using the conductive element to electrically couple a portion of the plurality of portions corresponding to the resistance to the conductive trace.

2. The assembly of claim 1, wherein the conductive element comprises a ball.

3. The assembly of claim 1, wherein the resistive trace and the conductive trace are configured to define a cavity and wherein the conductive element is disposed in the cavity.

4. The assembly of claim 3, wherein the roller ball sensor assembly further comprises a cover configured to define a portion of the cavity.

5. The assembly of claim 1, wherein the resistive trace comprises a first plurality of digits and wherein the conductive trace comprises a second plurality of digits.

6. The assembly of claim 5, wherein the first and second pluralities of digits are interdigitated.

7. The assembly of claim 6, wherein the conductive element is configured to electrically couple a digit of the first plurality of digits and a digit of the second plurality of digits adjacent the digit of the first plurality of digits.

8. The assembly of claim 1, wherein the roller ball sensor assembly further comprises:
a first contact coupled to the resistive trace; and
a second contact coupled to the conductive trace.

9. The assembly of claim 1, wherein each of the plurality of portions corresponds to a respective resistance of a stepwise range of resistances.

10. The assembly of claim 1, further comprising:
a float arm coupled to the sealed rotatable housing and configured to rotate the sealed rotatable housing about the axis based on the fuel level.

11. The assembly of claim 1, wherein the sealed rotatable housing holds an inert fluid.

12. An apparatus, comprising:
a roller ball sensor assembly, comprising:
a first trace;
a second trace; and
a ball configured to electrically couple a first portion of the first trace to the second trace responsive to the roller ball sensor assembly being positioned at a first angle and to electrically couple a second portion of the first trace to the second trace responsive to the roller ball sensor assembly being positioned at a second angle,
wherein the roller ball sensor assembly is configured to provide a first resistance responsive to the ball electrically coupling the first portion of the first trace to the second trace, and to provide a second resistance different from the first resistance responsive to the ball electrically coupling the second portion of the first trace to the second trace.

13. The roller ball sensor assembly of claim 12, wherein the first trace and the second trace are configured to define a cavity and wherein the ball is disposed in the cavity.

14. The roller ball sensor assembly of claim 12, wherein the first trace comprises polymeric ink, cermet-type ink, or a combination thereof.

15. The roller ball sensor assembly of claim 12, wherein the first trace comprises a first plurality of digits and the second trace comprises a second plurality of digits,
wherein the ball is configured to electrically couple the first portion of the first trace to the second trace by coupling a first digit of the first plurality of digits to a first digit of the second plurality of digits, and wherein the ball is configured to electrically couple the second portion of the first trace to the second trace by coupling a second digit of the first plurality of digits to at least one of the first digit of the second plurality of digits or a second digit of the second plurality of digits.

16. The roller ball sensor assembly of claim 15, wherein the first and second pluralities of digits are interdigitated.

17. The roller ball sensor assembly of claim 12, wherein the first angle corresponds to a first fuel level and the second angle corresponds to a second fuel level different from the first fuel level.

18. The roller ball sensor assembly of claim 12, wherein the first trace comprises a resistive trace and the second trace comprises at least one of a conductive trace or a resistive trace.

19. A method of sensing fuel levels in a fuel tank, the method comprising:
providing a fuel sensor, the fuel sensor comprising:
a rotatable housing configured to rotate about an axis and comprising a roller ball sensor assembly, the roller ball sensor assembly configured to sense a resistance indicative of a rotation of the rotatable housing about the axis,
wherein the roller ball sensor assembly comprises:
a resistive trace having a plurality of portions;
a conductive trace; and
a conductive element,
wherein the roller ball sensor assembly is configured to provide the resistance indicative of the rotation of the rotatable housing about the axis by electrically coupling a portion of the plurality of portions corresponding to the resistance to the conductive trace using the conductive element.
